(19) United States
(12) Patent Application Publication
(10) Pub. No.: US 2014/0119153 A1
(43) Pub. Date: May 1, 2014

(54) EXTRUDER SCREW WITH CHANNEL

(71) Applicant: The Goodyear Tire & Rubber Company, Akron, OH (US)

(72) Inventors: Warren Paul Ripple, North Canton, OH (US); Ernest Wilford Looman, JR., Tallmadge, OH (US); Patrice De Monte, Arlon (BE); Malcolm George Marshall, Wadsworth, OH (US)

(21) Appl. No.: 13/661,392

(22) Filed: Oct. 26, 2012

(51) Int. Cl. B29B 7/80; B29C 47/38

(52) U.S. Cl. 366/90

(57) ABSTRACT

An extruder apparatus is disclosed and which includes a cylindrical barrel having a feed end and a discharge end, the feed end having an outlet in fluid communication with a feed box. The extruder screw is mounted in the cylindrical barrel, and the screw has an outer surface having one or more helical flights mounted thereon. The screw has a discharge end and a terminal end, wherein the screw further comprising a notch at the terminal end.

### FIELD OF THE INVENTION

The invention relates in general to extruders for rubber processing, and more particularly to an extruder screw.

### BACKGROUND OF THE INVENTION

It is known in the art to extrude visco-elastic materials such as rubber, using a screw extruder. It is known in the art to utilize a feedbox to feed slabs of rubber compound into the extruder. One problem that may occur is that the slab of rubber will shear off due to slab feed tension, commonly referred to as slab “bite off”. This typically occurs when low strength compounds are utilized, particularly tread compounds. The problem is worsened by the “scissors” action on the screw flights against the feed roll and feedbox. If the feed strip breaks, it will result in workers having to clean out the feed box. Thus it is desired to have an improved extruder screw that overcomes the slab bite off problem.

### SUMMARY OF THE INVENTION

### Definitions

Feed Hopper—typically a cone-shaped slab feed “chute” which attaches to the top of an extruder feedbox. The feed hopper establishes folds in the compound slab feeding into the extruder.

Feedbox—that area of an extruder, where the screw is exposed to accept a rubber slab feed. Typical cold feed extruders have a driven feed roll assembly which forms a pinch area with the screw flights and serves to pull slab compound through the feed hopper and fill the screw flights. The feed roll assembly is usually a hinged assembly, which can be opened for cleaning and greater maintenance access to the screw and feedbox.

Cold Feed Extruder—a piece of machinery for processing visco-elastic materials, including rubber. This machine accepts cold compound in slab form, warms the compound and moves the compound from the feedbox to the end of the barrel, by means of a rotating mechanical screw.

### BRIEF DESCRIPTION OF THE DRAWINGS

The invention will be described by way of example and with reference to the accompanying drawings in which:

FIG. 1 is a schematic cutaway view of an extruder and flow head assembly.

FIG. 2 is a top view of a feed box and feed roll.

FIGS. 3-6 illustrate alternate embodiments of the notch for the extruder screw.

### DETAILED DESCRIPTION OF THE INVENTION

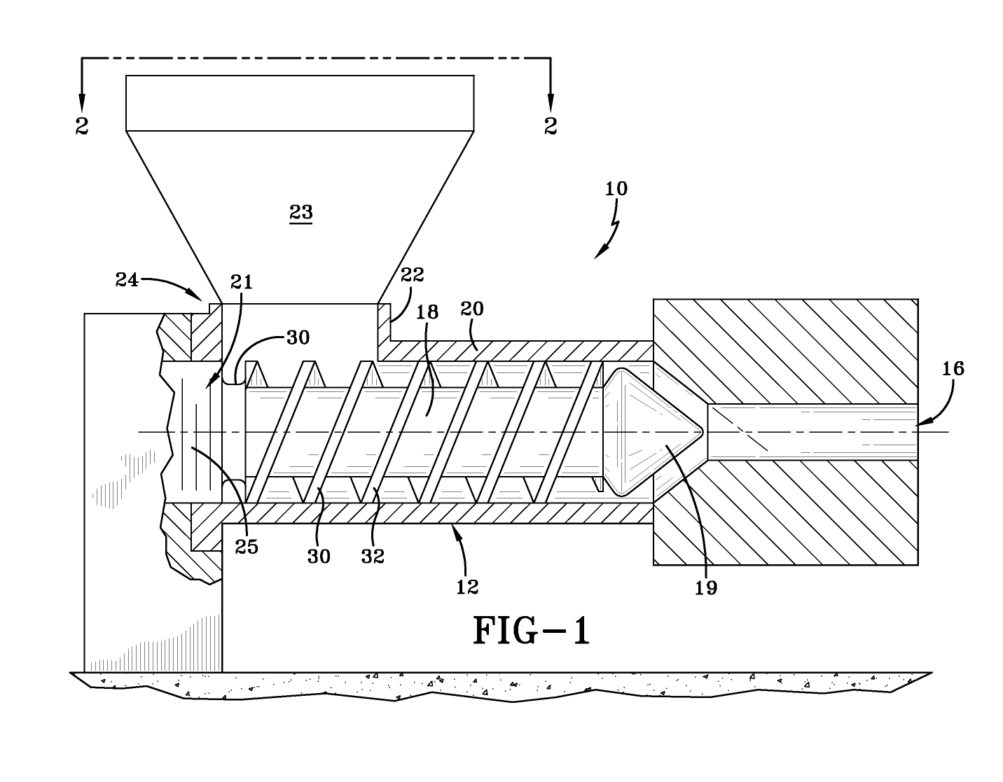

FIG. 1 illustrates an extruder flow head assembly 10 which includes an extruder screw 12 connected to a flow head 14 with a flow channel 16 leading to a die (not shown). The screw together with the die may be used to form a rubber component of visco-elastic material, such as rubber.

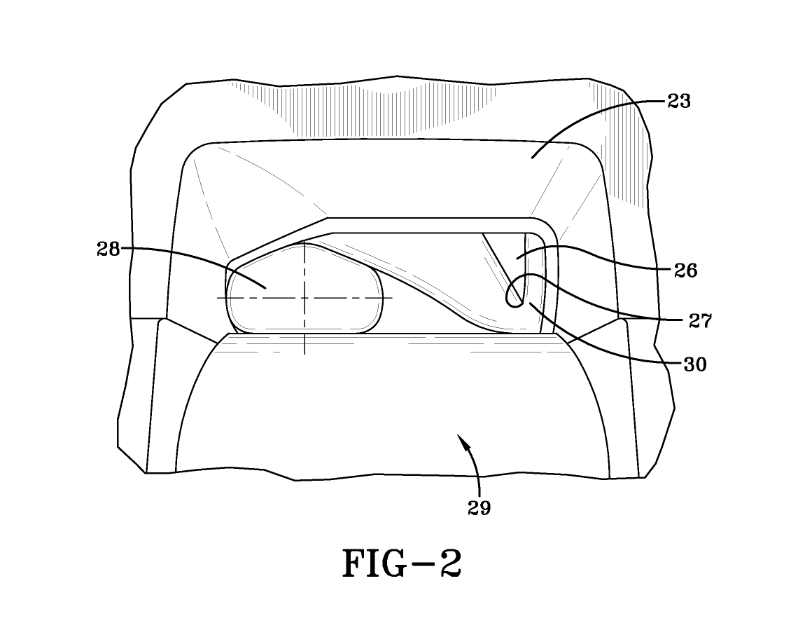

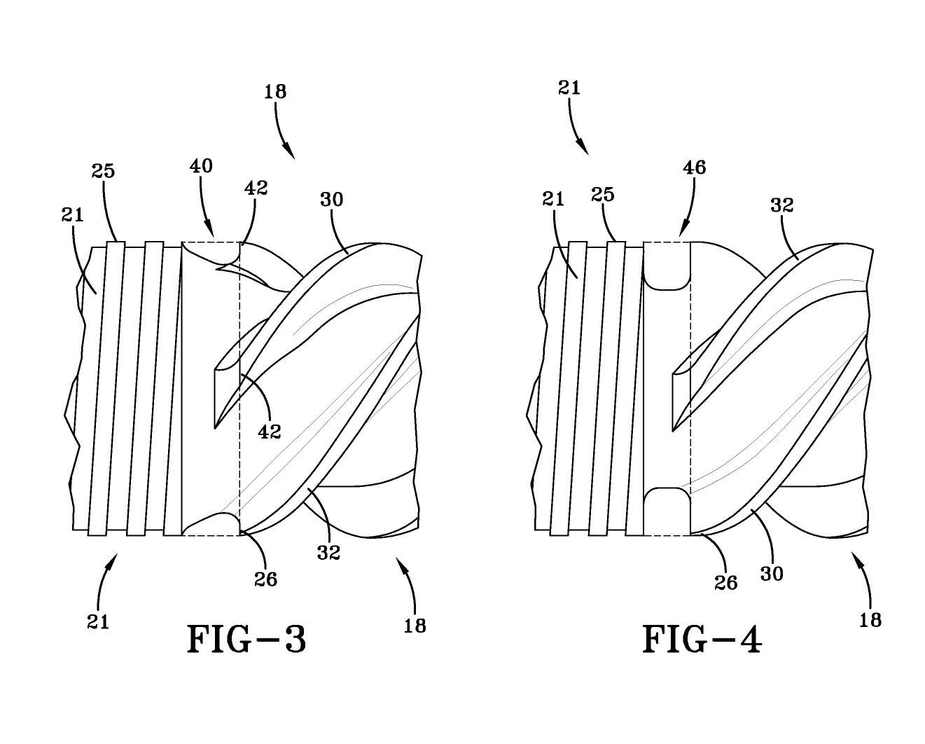

The extruder 12 has a screw 18 that is rotatable in a cylindrical barrel 20. The cylindrical barrel has an internal channel for housing the screw. The screw has an elongate cylindrical body 13 having at least two helical screw flights 30,32 mounted thereon. The screw is typically rotated by power means such as a motor and gearbox (not shown). The screw has a first discharge end forming a nose 19 and a second terminal end 21, typically having shallow flights 25 for keeping compound out of the splined screw-to-gearbox interface (not shown). The barrel 20 has a feed opening 22 at an entrance end 24 of the extruder. The feed opening is connected to a feed hopper 23. FIG. 2 illustrates the feed box at the entrance end of the extruder. The feed box has a screw, with the start of a screw flight 26. The screw depicted is a screw with a notch 30 machined into the screw in the area where the screw flight starts, 26. The action of the screw flight against the feed roll 29, tends to cut the rubber slab feed going into the feedbox. By machining a notch 30,40,46,50,60 (or channel) into this area of the screw (40 on FIG. 3) the screw flight is discontinuous and the scissors action of the screw flight against the feed roll will not cut off the compound slab feeding into the feedbox. The feedbox 23, typically exhibits a rolling ball 28 of compound, which indicates that the screw is properly fed (absence indicates underfeeding). It is important that the rubber slab being fed into the feedbox does not interfere with the rolling ball of compound, or the action of the rolling ball and the slab can also cause a slab bite-off. By directing the slab feed towards the rear of the feedbox and towards the screw notch or feed channel, interference with the rolling ball is avoided and the notch is allowed to provide a positive feeding assist. The use of a screw with a notch and a feed hopper with a guide keeping the slab from the rolling compound ball, greatly improves the occurrence of slab misfeeds, which are most prevalent with compounds having low “green strength”.

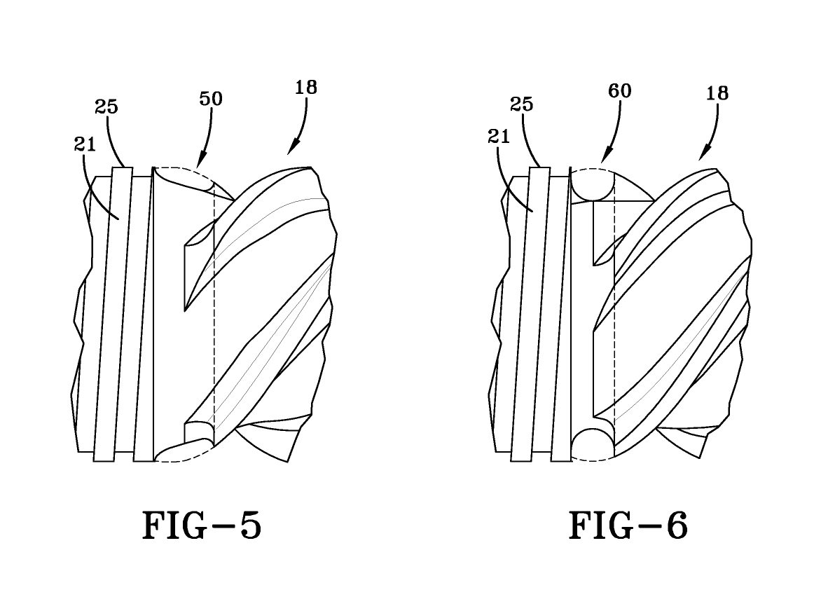

The rear end 21 of the extruder screw has been modified as shown in FIGS. 3-6. At the rear end 21 of the extruder end located where the helical flights are initiated, a notch 40 has been inserted in the screw flight at the terminal end near the feed box. As shown in FIG. 3, the notch 40 is circumferentially continuous, ie, it extends completely around the circumference of the screw. The notch cuts across the terminal ends 42 of the helical flights 30,32. The notch as shown in FIG. 3, is nonsymmetrical in shape. FIG. 4 illustrates a symmetrical, U shaped notch 46. FIG. 5 illustrates another asymmetrical notch 50 having a shallow depth. FIG. 6 illustrates a deep notch having a circular, symmetrical shape 60. The notch width of any of the above described notches may range from about 8 to about 40 mm depending upon the screw size, (increasing notch width with increasing screw diameter). The notch depth is preferably about ⅓ to about ⅔ of the channel width.

Experiments were conducted with a notched extruder screw over a range of speeds. It was observed that the notch reduced the number of misfeeds. It was also observed that directing the rubber into the feedbox area occupied by the rolling ball of compound could still cause a misfeed, but the action of the screw notch had the unexpected result that the feed was able to restart itself without any intervention. Complete clean-out of the extruder feedbox is typically required to re-establish normal compound feeding, with traditional extruder screws lacking the screw notch.

While certain representative embodiments have been shown for the purpose of illustrating the invention, it will be apparent to those skilled in the art that various changes and modifications can be made without departing from the scope of the invention.

What is claimed is:

1. An extruder apparatus comprising:
A cylindrical barrel having a feed end and a discharge end, the feed end having an outlet in fluid communication with a feed box, an extruder screw mounted in the cylindrical barrel, said screw having an outer surface having one or more helical flights mounted thereon, said screw having a discharge end and a terminal end, said screw further comprising a notch.

2. The apparatus of claim 1 wherein the notch is circumferentially continuous.

3. The apparatus of claim 1 wherein the notch has a symmetrical cross-sectional shape.

4. The apparatus of claim 1 wherein the notch has an asymmetrical cross-sectional shape.

5. The apparatus of claim 1 wherein the notch has a width in the range of about 5 to 40 mm.

6. The apparatus of claim 1 wherein the notch is formed adjacent the screw flights.

7. The apparatus of claim 1 wherein the notch intersects at least one of the helical screw flights.

8. The apparatus of claim 1 wherein the notch has a symmetrical U cross-sectional shape.

9. The apparatus of claim 1 wherein the notch has a semicircular cross-sectional shape.

10. The apparatus of claim 1 wherein the notch is between the screw helical flights and the terminal end.
